(19) United States
(12) Patent Application Publication
(10) Pub. No.: US 2026/0179226 A1
(43) Pub. Date: Jun. 25, 2026

(54) SYSTEMS AND METHODS FOR GENERATING WHOLE-TOOTH GEOMETRIC MESHES

(71) Applicant: Ormco Corporation, Brea, CA (US)

(72) Inventors: Ben Jeuris, Borgerhout (BE); Pieter Van Leemput, Rumst (BE); Juan Manuel Trippel Nagel, Bahia Blanca (AR); Rafael Gaitán Linares, Etterbek (BE)

(21) Appl. No.: 19/124,565

(22) PCT Filed: Oct. 26, 2023
(86) PCT No.: PCT/US2023/077828

§ 371 Date: Apr. 25, 2025

Related U.S. Application Data
(60) Provisional application No. 63/380,969, filed on Oct. 26, 2022.

(51) Int. Cl. G06T 7/11; A61C 7/00; A61C 7/14; G06T 17/00

(52) U.S. Cl. CPC G06T 7/11; A61C 7/00; A61C 7/002; A61C 7/146; G06T 17/00; G06T 2207/30196

(57) ABSTRACT

Systems and methods for generating a whole-tooth model geometric mesh from surface data and volumetric image data are disclosed. Whole-tooth geometric meshes are generated in a computationally-efficient manner. The method for segmenting a whole-tooth model from volumetric image data and intraoral surface data includes providing volumetric image data of dental anatomy, providing intraoral surface data of the dental anatomy, and generating augmented image data including both volumetric image and intraoral surface data by aligning said surface and volumetric image data. The crown sections in the intraoral surface data are segmented. The method includes selecting a template tooth from a library. The anatomical identification corresponds to the identification of a tooth of the image data. This template tooth is fitted to said tooth of the augmented image data. The whole-tooth model geometric mesh is provided by segmenting the tooth in the volumetric image data based on the fitted template tooth.

### BACKGROUND

It is helpful when planning a dental restorative, endodontic, orthodontic or maxillofacial surgery treatment to have a virtual representation of a patient's actual teeth. In recent years, computer-based systems and methods have been developed and implemented that use three-dimensional data (3D-Data) and three-dimensional models for generating such virtual representations. This development is based on increasingly sophisticated imaging techniques such as computer tomography (CT), in particular Cone Beam Computer Tomography (CBCT), which also allow for an assessment of non-visible areas of a patient's dentition. Although these imaging techniques provide a dental professional with images to readily assess a dental situation visually, the 3D-Data has a potential that goes beyond this visual assessment. For this, the data behind the images can be analyzed so that it becomes possible to supplement the images with content in relation to the dental situation that assists a dental professional in planning a treatment. In case of CT or CBCT-Data, the data may be segmented. However, the segmentation of one or more teeth from a CT or CBCT-image into separate entities is challenging due to the similar density of a dental root and the surrounding bone as well as areas of contact between adjacent teeth. Further, there are often high intensity streak artifacts present that are, for example, caused by dense dental fillings or at the interstices between adjacent crowns and make it hard to clearly delineate the crown region of a tooth. Further, the jawbone and teeth are not homogeneous in density. Both vary in type underneath their respective surfaces. On a macro-level, the jawbone is composed of cortical and cancellous bone tissue, whereas the teeth comprise enamel and dentin. These materials have overlapping densities so that it becomes hard to clearly differentiate between them. In addition, these tissues are porous to different degrees on a micro-level so that these different types of tissue regularly result in weak and erratic edges when visualizing their structure.

A virtual geometric mesh of an actual tooth can be generated using scan data from intraoral (10) surface data, such as obtained by scanning dental impressions or casts thereof or by direct intraoral scanning and volumetric image data, such as obtained with CT or CB CT. IO surface data provides high-resolution data but only for the crown portion of the tooth. volumetric image data provides whole-tooth data but the resolution in the root region can be noisy. A challenge exists for finding computationally-efficient methods for generating an accurate whole-tooth geometric mesh of a patient's tooth based on scanning data.

### SUMMARY

The present disclosure is directed to methods and systems for generating a whole-tooth model geometric mesh, comprising both a root and crown section mesh, from surface data and volumetric image data each representing a corresponding portion of a patient's dental arch. Accurate whole-tooth geometric meshes are generated in a computationally-efficient manner by the methods and systems disclosed herein. In an arrangement the computer-implemented method for segmenting a whole-tooth model from volumetric image data and intraoral surface data of a subject's dental anatomy comprises following initial steps: (i) providing volumetric image data of the dental anatomy, (ii) providing intraoral surface data of the dental anatomy and (iii) generating augmented image data comprising both the volumetric image and intraoral surface data by aligning said surface and volumetric image data. Preferably, (iv) the crown sections of the teeth in the intraoral surface data are segmented. The method further comprises (v) selecting a template tooth from a template tooth library (also referred as “root library”). Preferably, the anatomical denomination as indicated by for instance the tooth number (herein referred to as the “tooth identification” or “identification”) of this template tooth corresponds to the identification of a given tooth of the augmented image data. This corresponding template tooth is then (vi) fitted to said tooth of the augmented image data, wherein the whole-tooth model geometric mesh is provided by (vii) segmenting the tooth in the volumetric image data based on the fitted template tooth.

Typically, fitting a template tooth to the corresponding tooth in the augmented image data comprises aligning the template tooth to the segmented crown section of said tooth. Preferably, said fitting further comprises a scaled rigid transform of the corresponding template tooth relative to the segmented crown section of said tooth in the augmented image data.

In an embodiment, the aligning and/or scaled rigid registration of a template tooth to a segmented crown section in the augmented image data is automatically performed by the computer without requiring user input. This embodiment typically involves the selection of two or more template teeth from a template tooth library, wherein the tooth identification of each of the selected template teeth corresponds to the identification of a tooth of the augmented image data. The selected template teeth are then virtually positioned into a dental arch, for instance by virtually placing the selected template teeth at the respective positions of teeth with a same tooth identification in a reference dental arch. Subsequently, the template teeth can be aligned to the corresponding teeth in the augmented image data by performing a scaled rigid transformation of said virtual dental arch, wherein the crown center positions of the template teeth positioned in said virtual dental arch are mapped to the crown center positions as detected for the corresponding teeth in the augmented image data. In this embodiment, the tooth center positions of the template teeth can be predetermined and stored as part of the template data. Optionally, this aligning is followed by rigidly scaling the template teeth based on the distances between the crown center positions of corresponding neighboring teeth in the augmented image data. The aligned template teeth may then further be subjected to a scaled rigid transformation relative to the segmented crown sections of the respective corresponding teeth of the augmented image data. The step of aligning and subsequently rigidly scaling the template tooth relative to the segmented crown section is herein referred to as the rigid initialization step.

The method for segmenting a whole-tooth model from volumetric image data and intraoral surface data of a subject's dental anatomy according to the method of the present invention may comprise determining an outline of the root section of a tooth in the augmented image data. This root section is represented in the volumetric image data of the augmented image data. Determining an outline of the root section of a tooth includes determining edge points of said tooth in the volumetric image data starting from the edge points coinciding with the apical border of the segmented crown section of the aligned surface data and propagating these edge points in an apical direction along the root edge of said tooth in the volumetric image data. Propagating the edge points in an apical direction along the root edge of the tooth in the volumetric image data is preferably done in an iterative stepwise process. Typically, this process starts with identifying the edge points in the volumetric image data coinciding with the apical border of said segmented crown section whereafter at each step new edge points are sought in an apical direction from the respective edge points identified in a previous step. In an arrangement, the step size in the apical direction is separately determined for each such current edge point in any given iteration of the process. The step size may vary between 0 and 5 voxels, such as between 0.5 and 3 or 0.5 and 2 voxels. Preferably, a higher step size is used for edge points which are more distant from the presumed apex than for the edge points closer to the presumed apex. In this way the edge points are forced to converge to a same plane. Once edge points have substantially converged to a same plane, the step size is preferably similar for the edge points within said plane.

At an iteration the stepwise process for outlining the root section of a tooth is guided by a root direction and an inward direction at a current edge point. Said inward direction points from said current edge point to the inside of the root. Typically, said inward direction is provided by the gradient direction at a given edge position of said tooth. The root direction provides an indication of the direction towards a root apex position. The root direction for a tooth of the augmented image data may be obtained from the alignment of a template tooth to the segmented crown section of said tooth, wherein the tooth identification of the template tooth corresponds that of said tooth of the augmented image data. In a further arrangement the tooth direction is provided by performing a scaled rigid transform of said corresponding aligned template tooth relative to the segmented crown surface of said tooth of the augmented image data. Alternatively, said root direction is an adaptive direction provided by the direction between the crown center of a tooth of the augmented image data and the center of a current collection edge points in a given iteration.

The process of determining an outline of the root section of a tooth in the augmented image data may further comprise testing a collection of edge points for convergence towards a same position within said volumetric image data. Such convergence may indicate that said collection of edge points approaches a root apex position. So, in an arrangement of the method of the present invention an apex landmark position is derived from a collection of edge points having passed said convergence test.

After the identification of an apex landmark, an outline of a root section of a tooth in the augmented image data may be determined by the voxel positions of the edge points detected in the iterative steps leading up to a said converging collection of edge points used to identify said apex landmark. Herein the outline of a root section of a tooth of the augmented image data is also referred to as “mantle”. The number of apices identified for a tooth of the augmented image data as described above may be used to select a template tooth with a same number of apices for fitting this template tooth to said tooth according to the method of the present invention.

The method for segmenting a whole-tooth model from volumetric image data and intraoral surface data of a subject's dental anatomy according to the method of the present invention comprises fitting a template tooth to a tooth of the augmented image data. It was previously indicated that this fitting may comprise aligning and subsequently applying a scaled rigid transform on the corresponding template tooth relative to the segmented crown section of said tooth in the augmented image data. Fitting the corresponding template tooth to the tooth of the augmented image data may further include non-rigidly deforming the template tooth to a deformed template tooth mesh that matches the segmented crown section and preferably a root apex landmark position of the tooth of the augmented image data. In an arrangement this root apex landmark may be automatically identified as discussed above. Alternatively, the apex landmark is indicated by the user in a user interface. This deformed template tooth mesh provides a tooth model of which the crown section and overall dimensions closely match that of the corresponding tooth in the augmented image data.

In a further step the root section of said deformed template tooth is registered to the root section of the tooth in the augmented image data and more particularly in the volumetric image data. Preferably, the fitting of the root section of the deformed template tooth is preceded by the labeling of its vertices as crown vertices or root vertices based on the proximity between the deformed template tooth mesh and the segmented crown section of the matching tooth of the augmented image data. In an embodiment, the labeling of the vertices of the deformed template tooth mesh comprises determining for each vertex on the deformed template tooth mesh the distance to the nearest point on the segmented crown surface mesh, preferably such nearest point is not restricted to a vertex of the segmented crown section but can also lie on any of the faces or edges of said surface. If for a vertex of the deformed template tooth this distance is lower than a given threshold, such as below 0.4, 0.3, 0.2 or 0.1 mm, said vertex is labeled as part of the crown section, otherwise said vertex is labeled as part of the root section. After labeling of the crown and root section vertices of the deformed template tooth, the root section of the deformed template tooth mesh may be further non-rigidly deformed to align the vertices of the root section with an edge of the selected tooth in the volumetric image data. In an arrangement deforming the root section of the deformed template tooth mesh to align the vertices of the root section with an edge of the selected tooth in the volumetric image data comprises a coarse registration step wherein the vertices of the root section of the deformed template tooth mesh are aligned with the outline of the root of the tooth in the augmented image data as described above. Preferably this coarse registration step is followed by a fine registration wherein the root section of the deformed template tooth mesh is further registered to the root edge of the corresponding tooth in the volumetric image data.

It is a further object of the present invention to provide a computer system comprising: memory; and a processor in communication with the memory and configured with processor-executable instructions to perform operations comprising: (i) receiving volumetric image data of a subject's dental anatomy; (ii) receiving intraoral surface data of the dental anatomy; (iii) generating augmented image data by aligning the surface data and the volumetric image data; (iv) segmenting crown sections of teeth in the intraoral surface data; (v) selecting a template tooth from a template tooth library, wherein the tooth identification of the template tooth corresponds to the identification of a tooth of the augmented image data; (vi) fitting the corresponding template tooth to said tooth of the augmented image data; and (vii) segmenting the tooth in the volumetric image data based on the fitted template tooth.

In a further object the present invention provides a non-transitory computer readable medium storing computer executable instructions that, when executed by one or more computer systems, configure the one or more computer systems to perform operations comprising: (i) receiving volumetric image data of a subject's dental anatomy; (ii) receiving intraoral surface data of the dental anatomy; (iii) generating augmented image data by aligning the surface data and the volumetric image data; (iv) segmenting crown sections of teeth in the intraoral surface data; (v) selecting a template tooth from a template tooth library, wherein the tooth identification of the template tooth corresponds to the identification of a tooth of the augmented image data; (vi) fitting the corresponding template tooth to said tooth of the augmented image data; and (vii) segmenting the tooth in the volumetric image data based on the fitted template tooth.

Preferably a template tooth used in the method and/or system of the present invention comprises a crown section mesh and a root section mesh, with the mesh density of the crown section mesh being higher than the mesh density of the root section mesh. Typically, the mesh density of a crown section should correspond to the mesh density of dental surface scans as are typically obtained using intraoral scanning or by scanning dental impressions or plaster casts. The mesh density of the crown mesh sections of a template tooth surface as determined by the average edge length may be between 0.06 and 0.15 mm, for instance between 0.08 and 0.15 mm, such as between 0.09 and 0.13 On the other hand, the root mesh section of a template tooth surface should typically reflect the lower resolution (as compared to dental surface scans) of the contours derived from CT or CBCT scan data. The mesh density of the root mesh sections of the template tooth surfaces may be between 0.15 and 0.30, for instance between 0.15 and 0.25, such as between 0.15 and 0.22 In an embodiment the average edge length of the root mesh section is at least 1.1 times, for instance at least 1.3 times, such as at least 1.5 times, higher than the mesh density of the root mesh section.

### BRIEF DESCRIPTION OF THE DRAWINGS

Embodiments of the present disclosure will now be described hereinafter, by way of example only, with reference to the accompanying drawings in which:

FIG. 1 depicts a schematic diagram of a mesh-generating system, according to some aspects of the present disclosure.

FIG. 2 illustrates a mesh-generating method, according to some aspects of the present disclosure.

FIG. 3 shows an IO scan aligned with a CBCT scan.

FIG. 4A shows a segmented mesh from an IO scan before separation of individual crown meshes.

FIG. 4B illustrates the mesh of FIG. 4A after separation of individual crown meshes.

FIG. 5A shows a crown mesh from an IO scan.

FIG. 5B shows the crown mesh of FIG. 5A overlaid on a template mesh.

FIG. 6 shows a plurality of whole-tooth geometric meshes following a rigid registration process, according to some aspects of the present disclosure.

FIG. 7 shows a boundary edge of an IO-scan crown mesh.

FIG. 8A depicts a method of determining a next location of an edge point on a mesh mantle, according to some aspects of the present disclosure.

FIG. 8B shows an axial plane view of a collection of edge points, according to some aspects of the present disclosure.

FIG. 9A shows an early-stage progression of edge points that are advancing apically away from the crown mesh to define the root mantle, according to some aspects of the present disclosure, with the template mesh being shown for illustrative purposes only.

FIG. 9B shows the edge points of FIG. 9A after a further progression of the edge points.

FIG. 9C shows the edge points of FIG. 9B after a further progression of the edge points.

FIG. 9D shows the edge points of FIG. 9C after a further progression of the edge points.

FIG. 10 shows a schematic diagram of a step-correction method that can be applied to edge points that have converged to plane orthogonal to the root direction, according to some aspects of the present disclosure.

FIG. 11A illustrates a method for evaluating an apical convergence of a set of edge points, according to some aspects of the present disclosure.

FIG. 11B shows the method of FIG. 11A applied for a different collection of edge points.

FIG. 11C shows the method of FIG. 11A applied for a different collection of edge points.

FIG. 12A illustrates a method for evaluating an apical convergence of a set of edge points, according to some aspects of the present disclosure.

FIG. 12B shows the method of FIG. 12A applied for a different collection of edge points.

FIG. 12C shows the method of FIG. 12A applied for a different collection of edge points.

FIG. 13A illustrates a method for evaluating an apical convergence of a set of edge points, according to some aspects of the present disclosure.

FIG. 13B shows the method of FIG. 13A applied for a different collection of edge points.

FIG. 14 illustrates a filtering method for determining whether an edge point has converged to a root apice of a neighboring tooth.

FIG. 15A illustrates location histories for a collection of edge points, according to some aspects of the present disclosure.

FIG. 15B illustrates location histories for a collection of edge points, according to some aspects of the present disclosure.

FIG. 15C illustrates location histories for a collection of edge points, according to some aspects of the present disclosure.

FIG. 16A illustrates bands of edge points following a fine registration process, according to some aspects of the present disclosure.

FIG. 16B illustrates bands of edge points following a fine registration process, according to some aspects of the present disclosure.

FIG. 16C illustrates bands of edge points following a fine registration process, according to some aspects of the present disclosure.

FIG. 16D illustrates bands of edge points following a fine registration process, according to some aspects of the present disclosure.

FIG. 17A illustrates a coronal-plane view of edge points after undergoing a fine registration process, according to some aspects of the present disclosure.

FIG. 17B illustrates a sagittal-plane view of edge points after undergoing a fine registration process, according to some aspects of the present disclosure.

FIG. 17C illustrates an axial-plane view of edge points after undergoing a fine registration process, according to some aspects of the present disclosure.

FIG. 18A illustrates a coronal-plane view of edge points after undergoing a fine registration process, according to some aspects of the present disclosure.

FIG. 18B illustrates a sagittal-plane view of edge points after undergoing a fine registration process, according to some aspects of the present disclosure.

FIG. 18C illustrates an axial-plane view of edge points after undergoing a fine registration process, according to some aspects of the present disclosure.

FIG. 19A illustrates a coronal-plane view of edge points after undergoing a fine registration process, according to some aspects of the present disclosure.

FIG. 19B illustrates a sagittal-plane view of edge points after undergoing a fine registration process, according to some aspects of the present disclosure.

FIG. 19C illustrates an axial-plane view of edge points after undergoing a fine registration process, according to some aspects of the present disclosure.

FIG. 20A illustrates a right view of a patient's jaw.

FIG. 20B illustrates the patient's jaw view of FIG. 20A with an overlay of whole-tooth fitted templates, according to some aspects of the present disclosure.

FIG. 21A illustrates a left view of a patient's jaw.

FIG. 21B illustrates the patient's jaw view of FIG. 21A with an overlay of whole-tooth fitted templates, according to some aspects of the present disclosure.

FIG. 22 presents validation data for two data sets, according to some aspects of the present disclosure.

### DETAILED DESCRIPTION

This disclosure relates generally to methods and systems for generating whole-tooth geometric meshes. In some arrangements, whole-tooth mesh generated by the methods, systems, algorithms, or processes of the present disclosure can be used to plan or to assess a dental or maxillofacial surgery treatment plan. In some configurations, the methods or systems disclosed herein can include a fully-automatic software process that can reconstruct a whole-tooth mesh (comprising both crown and root surface) of a patient using volumetric image data, such as obtained by computed tomography (CT) or cone-beam computed tomography (CBCT), intraoral (10) surface data and a predefined three-dimensional (3D) tooth model that includes a crown and a root portion (a predefined 3D tooth model is also referred to herein as “template tooth” and a library comprising a set of template teeth is also referred herein as “library roots”).

In some arrangements, the method or the system can include an algorithm that can start from volumetric image data of a patient's dental arch or part thereof aligned with IO surface data. The method or system can include one or more of the following steps. A step can use the segmented crown faces from the IO surface data (herein also referred to as “segmented IO crowns” or “segmented crown sections”) to compute a direction, size, and rotation of where the roots should be placed and using this information to align and preferably scale a template tooth of the library roots to one or more segmented IO crowns, preferably to each segmented IO crown. A step can start from the segmented crown boundary edges of the IO surface data and can begin to search for the roots in the volumetric image data of one or more teeth until a set of possible apices are found. In some arrangements, the result can be a set of points covering the root in the volumetric data (also referred to herein as “mantle”) and the root apices for one or more teeth. A non-rigid crown and root registration step can be applied to one or more of the aligned template teeth using the segmented crowns and the points of the mantle. A banded deformation step can proceed from the gingival edge to the root apices and can be applied for fine adjustment of the template tooth shape. In some configurations, the gingival edge can be defined using a Line Around Tooth (LAT) line that is created from crown edge points, as described herein.

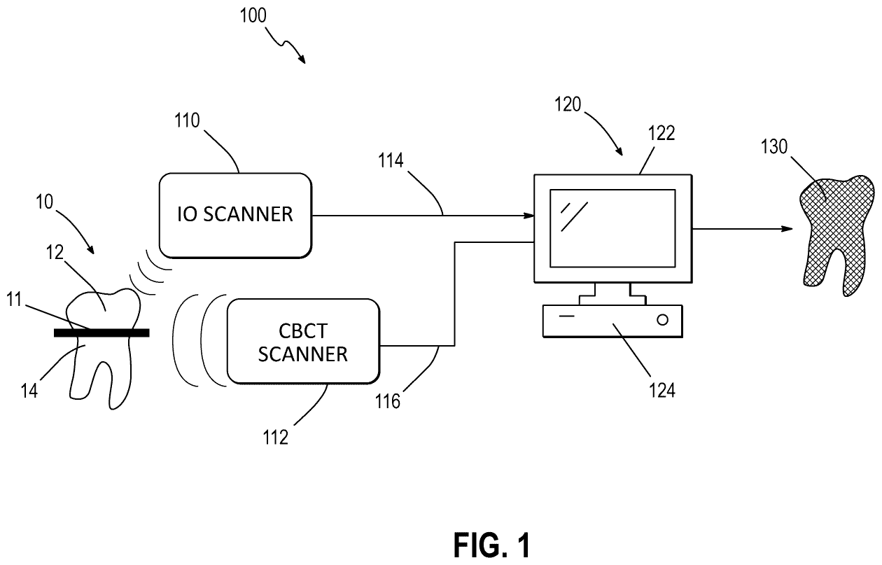

FIG. 1 depicts a schematic representation of a non-limiting, illustrative example of a whole-tooth mesh-generating system 100 according to some aspects of the present disclosure. In some arrangements, the system 100 can include an intra-oral (10) scanner 110 and a CT scanner or a cone-beam computed tomography (CBCT) scanner 112. Alternatively, or additionally, the system may include a desktop 3D scanner for scanning impressions of a patient's IO anatomy or plaster casts of such impressions. The 3D desktop or IO scanner 110 can be used to obtain surface data of the patient's IO anatomy and the CT or CBCT scanner 112 can be used to obtain volumetric image data of a maxillofacial region, including a portion of a jaw and one or more teeth. As shown schematically in FIG. 1, a tooth 10 of a patient can span a gingival line 11. A crown portion 12 of the tooth 10 can lie exposed above the gingival line 11. A root portion 14 of the tooth 10 can extend below the gingival line 11 toward the patient's jaw. The IO scanner 110 can obtain a high-resolution spatial scan of the crown portion 12 of the tooth 10 but cannot provide spatial information about the root portion 14. The CBCT scanner 112 can obtain spatial information about both the crown portion 12 and the root portion 14. However, the volumetric image data 116 of the root portion 14 tends to be noisy compared to IO surface data 114. As described herein, the system 100 can receive IO surface data 114 and corresponding volumetric image data 112 of a tooth 10 and return an accurate whole-tooth geometric mesh 130 of the tooth 10. In some variants, the system 100 can be fully-automated and not require human intervention to generate the whole-tooth mesh 130 from the IO surface data 114 and the volumetric image data 116.

With continued reference to FIG. 1, the system 100 can include a computer 120 with a display 122 and a processing unit 124. The processing unit 124 can be programmed or otherwise configured to execute the computational and analysis steps or methods described herein. The computer 120 can be configured to receive IO surface data 114 from the 3D desktop or IO scanner 110 and to receive volumetric image data 116 from the CT or CBCT scanner 112. The processing unit 124 can be configured to execute the computational and analytical methods described herein to generate a whole-tooth geometric mesh 130 from the IO surface data 114 and the volumetric image data 116.

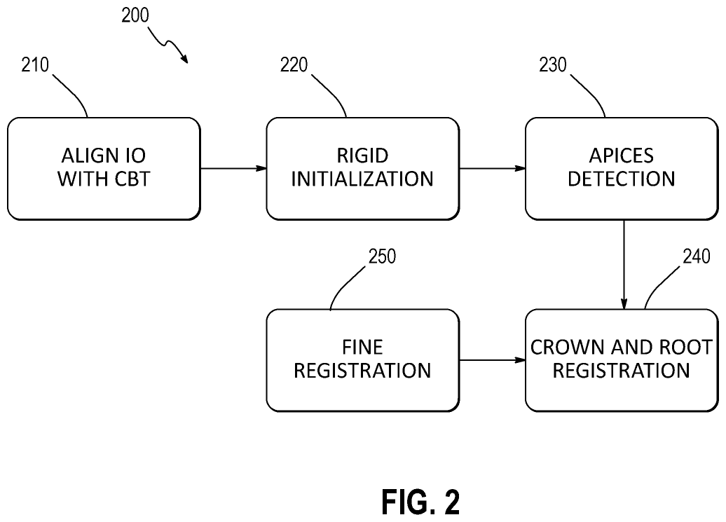

FIG. 2 depicts a schematic overview of a whole-tooth mesh-generating method 200. In some embodiments, the whole-tooth mesh-generating system 100 (FIG. 1) can be configured to perform the whole-tooth mesh-generating method 200. The whole-tooth mesh-generating method 200 can receive as input IO surface data and volumetric image data of a patient's teeth. The method 200 can include an alignment step 210 in which the IO surface data and volumetric image data are aligned with one another. The IO surface data aligned with the volumetric image data may be referred to as augmented image data. The method 200 can include a rigid initialization step 220 in which one or more template tooth meshes are aligned with one or more, preferably with all crown portions in the IO surface data 114. In some arrangements, the rigid initialization step 220 can include detecting an approximate position, size, and direction of one or more roots by said aligning of one or more template teeth of the library roots to the crown portions of the IO surface data in the augmented image data. The method 200 can include an apices detection step 230 in which a collection of edge points are tested for convergence as the edge points advance along a root portion of the volumetric image data. In some configurations, the apices detection step 230 can include performing an iterative search of the apices by segmenting the root in the volumetric image data from the voxels coinciding with the aligned crown mesh boundary edges until the apex or apices of the root are found. The method 200 can include a coarse registration step 240 in which the point histories of the converging edge points are used to form a mantle toward which the template tooth mesh can be deformed. In some arrangements, the coarse registration step 240 can include performing a non-rigid deformation of the crown and the root of the aligned template tooth to the segmented IO crowns and a set of points (mantle) found in the apices detection step 230, respectively. The method can include a fine registration step 250 in which a finer registration of the root vertices of the aligned and deformed template tooth to the volumetric image data is performed. In some configurations, the fine registration step 250 can include performing a gradual or banded optimization of the root surface starting from the crown boundary edges to improve the accuracy of the registration of the root section of said template tooth. Following said registration of the template tooth to the IO surface data and volumetric image data of a given tooth a fully segmented tooth model can be obtained based on said registered template tooth.

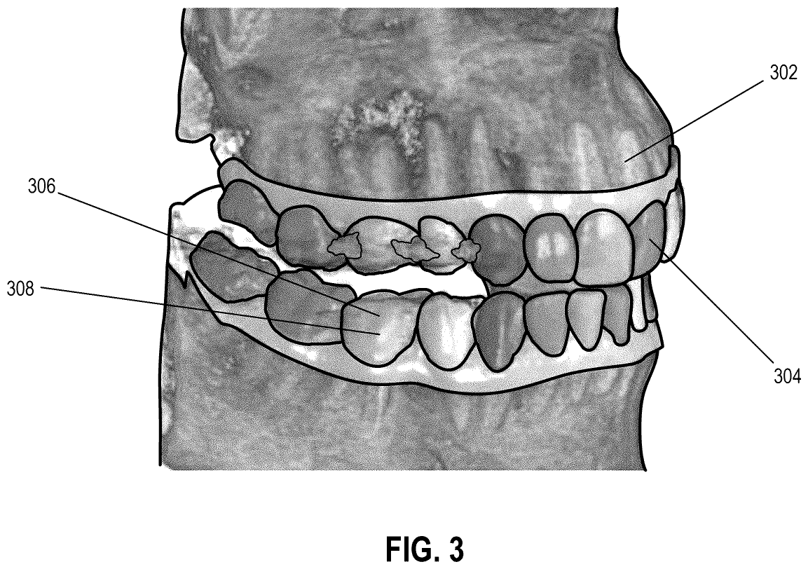

FIG. 3 illustrates a non-limiting exemplary embodiment of volumetric image data obtained from a CBCT scan 302 aligned with IO surface data obtained from an IO scan 304. In some arrangements, the CBCT scan 302 and the IO scan 304 are aligned with one another by aligning the CBCT crown portions 306 of the CBCT scan 302 with the IO crown portions 308 of the IO scan 304 or vice versa. In some arrangements, the method and the system can include an algorithm for which the input data for the algorithm is augmented image data comprising volumetric image data, for instance CBCT scan 302, aligned with the IO surface data, for instance IO scan 304 of the same patient. The algorithm can search and segment the roots within the CBCT scan 302, including the position of the apices, by extracting a set of points in 3D space for each root. After that, the template teeth from the library root will be registered with respect the segmented crowns and the CBCT root points identified during the segmentation.

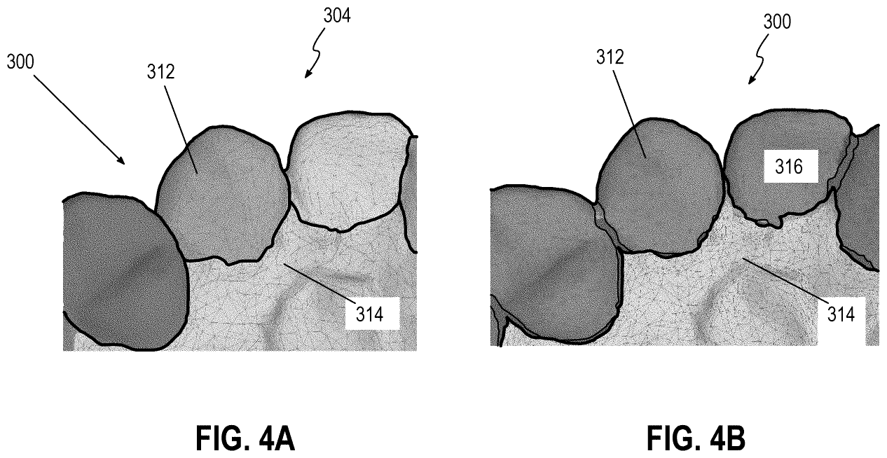

FIGS. 4A and 4B illustrate a trimming feature that can be included in the rigid initialization step 220. FIG. 4A shows the segmented IO surface mesh 300 obtained from an IO scan 304. The depicted segmented IO surface mesh 300 shows a plurality of tooth crowns 312 as well as a portion of the proximal tissue 314. In some variants, the segmented IO surface mesh 300 can include information about the tooth identification (ID, such as the tooth number) of each tooth. In some arrangements, the curvature of the crown faces of the segmented IO crown mesh 300 can be analyzed to define trimmed crown meshes faces that exclude the interproximal areas 316. FIG. 4B shows the segmented IO crown mesh 300 after the curvatures of the crown faces have been analyzed and the interproximal areas 316 have been removed. In some arrangements, the portion of the IO surface data representing soft tissue is identified as a separate tissue and can be identified or removed. In some arrangements, the rigid initialization step 220 can include selecting a template tooth from the library roots based on the tooth ID of the segmented IO crown mesh. The mesh of the selected template tooth can then be aligned with the segmented IO crown mesh.

Preferably, the registered template tooth has the same tooth ID as that of the segmented IO crown mesh to which it is aligned. The tooth type of each of the teeth in the augmented image requiring segmentation can be inputted by the user or is automatically determined. PCT application WO2023194500 discloses a method for automatically identifying the crown center positions and the tooth ID's (tooth numbers) of each of the teeth represented in the volumetric image data. The automatically detected tooth numbers can subsequently be used to choose the appropriate template tooth for aligning a template tooth to a segmented IO crown section 320 in the augmented data. Preferably, the template tooth is chosen from a roots library comprising one or more template teeth for each of the anatomical tooth types. Further, it is preferred that each of said template teeth comprises a crown section mesh connected to a root section mesh, wherein the density of the crown section mesh is higher than the mesh density of the root mesh section. Typically, the mesh density of a crown section should correspond to the mesh density of dental surface scans as are typically obtained using intraoral scanning or by scanning dental impressions or plaster casts. The mesh density of the crown mesh sections of a template tooth surface as determined by the average edge length may be between 0.06 and 0.15 mm, for instance between 0.08 and 0.15 mm, such as between 0.09 and 0.13 On the other hand, the root mesh section of a template tooth surface should typically reflect the lower resolution (as compared to dental surface scans) of the contours derived from CT or CBCT scan data. The mesh density of the root mesh sections of the template tooth surfaces may be between 0.15 and 0.30, for instance between 0.15 and 0.25, such as between 0.15 and 0.22 In an embodiment the average edge length of the root mesh section is at least 1.1 times, for instance at least 1.3 times, such as at least 1.5 times, higher than the mesh density of the root mesh section.

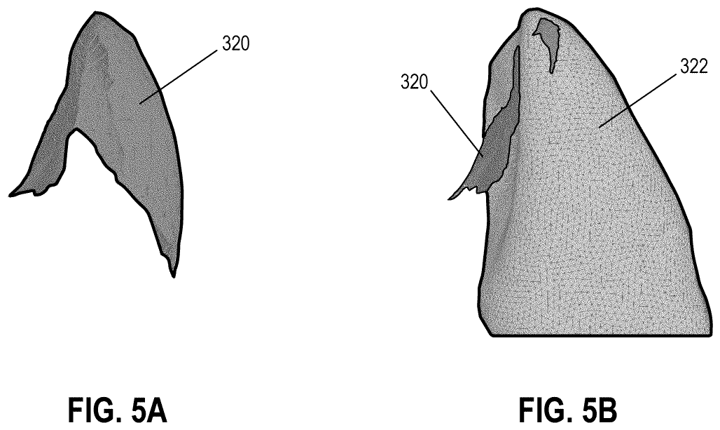

FIGS. 5A and 5B illustrate an alignment feature that can be included in the rigid initialization step 220. For each vertex of a segmented crown mesh 320, a corresponding point on the template tooth mesh 322 can be found. These correspondences can be used for iterative alignment and scaling using, for example, an iterative closest point (ICP) algorithm. FIG. 5A shows correspondence points from the crown mesh 320. FIG. 5B shows a tooth template mesh 322 aligned with the crown mesh 320.

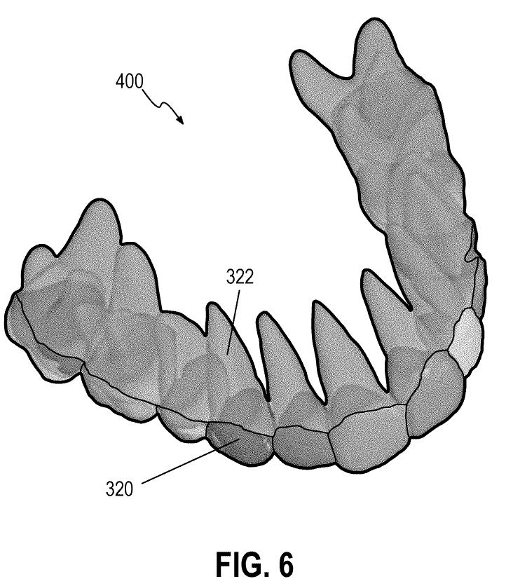

FIG. 6 illustrates a non-limiting exemplary rigid-scale-transform mesh 400 that can result from performing a rigid initialization step 220. The rigid initialization step 220 can include an algorithm that performs a rigid scale transform to determine the initial placement of the template tooth meshes 322 relative to the segmented crown meshes 320. In some variants, the rigid scale transform can provide an initial root direction in which to start the search algorithm for detecting root apices in the apices detection step 230.

In an arrangement, the aligning and/or scaled rigid registration of a template tooth to a segmented IO crown in the augmented image data is automatically performed by the computer without requiring user input. In an embodiment the template tooth models are automatically registered to the teeth in the augmented image data using crown center positions determined for both the teeth in the augmented image data and the corresponding template teeth, respectively. In this embodiment, the tooth center positions of the template teeth can be predetermined and stored as part of the template data. WO 2023194500 discloses a method for automatically identifying the crown center positions and tooth numbers of teeth represented in volumetric image data of a patient's maxillofacial region. Alternatively, the center position of an IO segmented crown can be determined by averaging the positions of all its vertices. Based on the tooth numbers as detected or determined for the teeth in the volumetric data of the augmented image data, corresponding template teeth are selected and positioned into a virtual dental arch, such an average dental arch obtained by averaging the arches and respective tooth positions as determined for a plurality of individual dental arches. For example, if the tooth numbers for all teeth of the upper jaw are present in the volumetric data, a set of model teeth is selected comprising a template tooth for each of the upper teeth, wherein these template teeth are positioned in an arch corresponding to the tooth arch of a virtual upper jaw. Subsequently, a scaled rigid transformation is applied on said virtual upper dental arch mapping the initial crown center positions of the template teeth to the crown center positions detected for the corresponding teeth in the augmented image data. Thereafter, the sizes of the individual template teeth can be updated based on the distance between neighboring tooth center positions. Preferably, this scaled rigid transformation is followed by a rigid mesh-based registration of each template tooth to the segmented IO crown section 320 of the corresponding tooth in the augmented image data. This additional mesh-based registration step may provide more accurate orientations of the respective template teeth. Typically, this further mesh-based registration comprises applying an Iterative Closest Point (ICP) algorithm, wherein closest point correspondences between vertices of the segmented crown surfaces and of the respective corresponding template teeth are determined. Preferably, closest point correspondences are determined for all vertices in the segmented crown surfaces with vertices in the respective corresponding template teeth, followed by establishing the optimal rigid transformation between the correspondences using a point-to-point cost function. For instance, using a Tukey-based cost function, wherein the Tukey distance parameter is set to 1 mm.

The combination of the aligned segmented crown mesh 320 and the scaled rigid initialization of the template tooth models in the rigid initialization step 220 can provide a lot of information on the crown surfaces and orientation of each tooth in the augmented image data. The information on the root level of each tooth is extracted from the volumetric image data because the roots are not present in the IO surface data. To address the situation that the volumetric image data can have a lower resolution and be noisier than the IO surface data, the system 100 or the method 200 can include an algorithm that can start by determining a rough general outline of the root (referred to herein as “mantle”) while attempting to detect the apex or apices of a tooth. The position of these detected apices will give a rough idea of the orientation and length of the root while also possibly providing an indication of the number of apices (i.e., the number of root segments) the tooth has. Detecting the number of apices correctly will allow the most suitable template tooth, i.e. a template tooth having the same tooth number and the same number of apices as a selected tooth in the image data, to be chosen in the upcoming registration steps. The rough outline, or mantle, of the root in the volumetric image data will be used to further initialize the root shape of the aligned template tooth.

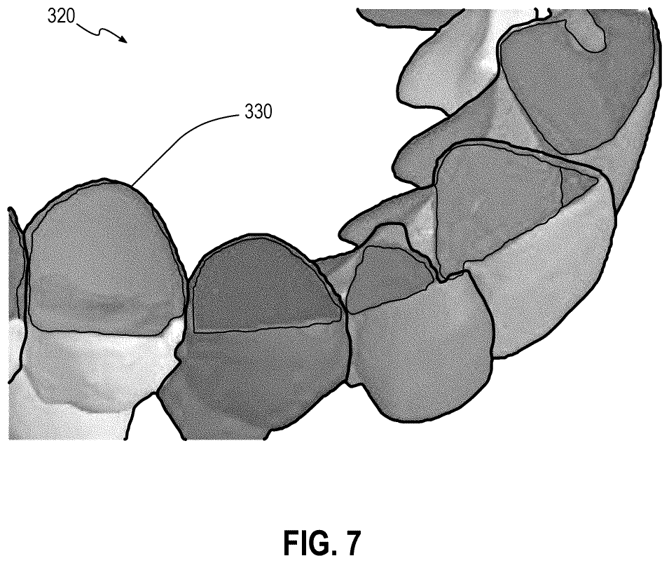

With reference to FIG. 7, the overall strategy in the apices detection step 230 is to start from the edge points 330 of the (accurate registered) crown meshes 320 and gradually propagate these points towards the apices in the volumetric image data along the root's edges. When approaching an apex, the edge points 330 should be properly clustered to detect their convergence. Once all edge points 330 have converged or a maximum number of steps is reached, a check can be performed on which converged clusters can be labeled as reliable. Based on these reliably converged clusters, an aggregated landmark position can be constructed, while the positions of the voxels that were visited in the intermediate steps to obtain such clusters can make up the mantle of the root.

FIG. 7 illustrates a non-limiting exemplary starting condition for propagating the edge points 330 in an apices detection step 230. The apex detection can be initiated by the Cartesian coordinates of the edge points 330 (crown boundary vertices) of a segmented IO crown mesh 320 in the augmented image data. Then, all voxels that the edge points 330 fall into can be retrieved and filtered to avoid duplicated voxels (e.g., multiple edge points 330 can be mapped to the same voxel).

The movement of each of the edge points 330 in the apices detection step 230 can use a root direction, an inward direction, and a step size, as described herein, to iteratively converge to find the possible root apex or apices. The movement of the edge points 330 can be divided into two main phases. The first phase can be designed to have the edge points 330 move sufficiently below the crown of the tooth, past any possible bright spots that can be caused by fillings or metal braces on top of the dental crown. In some arrangements, the initial rigid scale transform estimate obtained from the crown mesh rigid registration can be used for the root direction. In some arrangements, the center direction can be used for the inward direction to limit the chance of edge points deviating to neighbor teeth or nearby structures. In some variants, an adaptive step size can be used in which larger step size values can be scaled by voxel dimensions and considered for the lowest points while a smaller step size is applied for the highest points, forcing lower points to converge to the same plane of the higher points.

The second phase for movement of the edge points 330 can be configured to handle a wide variety of root shapes, as well as roots splitting into multiple segments, requiring more adaptability. An adaptive root direction can be used to capture the actual root direction on each step. In some configurations, the adaptive root direction can be defined by a center of the edge points 330 and a center determined for the segmented crown mesh 320 in the augmented image data. A center position of a segmented IO crown mesh may be determined by averaging the position of all vertices of said segmented IO crown mesh. For the inward direction, the gradient direction of the volumetric image data at the location of the edge point 330 can be used, providing more local information and possibly being better suited to handle multiple root segments. Similarly, an adaptive step size can be used to maintain the planar alignment of the edge points 330. In some variants, the same approach can be used but the step size value can be weighted using the inward direction.

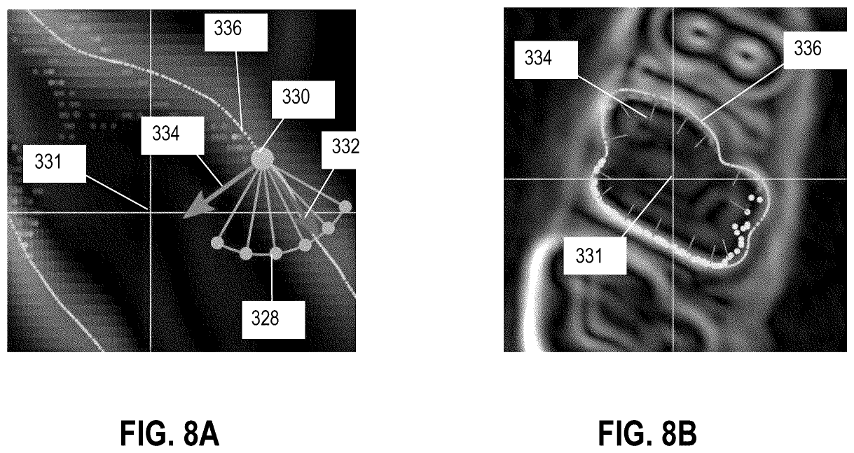

FIGS. 8A and 8B illustrate a non-limiting exemplary process for determining a movement of an edge point 330. To have the edge points 330 move towards the apices of the root, an estimated root direction 332 can be used for each of the edge points 330. The initial root direction can be defined by the initial rigid registration, however when the edge points 330 are coplanar, an adaptive root direction can be used. The adaptive root direction can be defined as the direction from the detected center of the segmented crown mesh in the augmented image data towards the mean of all the edge points 330 (the edge points center 331). To further guide the apex search from the crown edge to the root tip(s), an inward direction 334 can also be defined that is roughly perpendicular to the local edge surface 336 in the current edge point 330. FIG. 8A shows a volumetric image data slice intersection view demonstrating the different components in the movement of an edge point 330 during each iteration. By combining this inward direction 334 with the root direction 332, a plane can be defined that is roughly orthogonal to the circumferential edge of the root near the current edge point 330. FIG. 8B shows an axial slice intersection view demonstrating the plane and different inward directions 334 at various edge points 330. Once a root direction 332 and an inward direction 334 have been determined for a not converged edge point 330, the algorithm can start looking for its next position in the plane using the reference frame defined by the two directions: the root direction 332 and the inward direction 334. A set of possible step directions 328 can computed in the plane, as indicated in FIG. 8A.

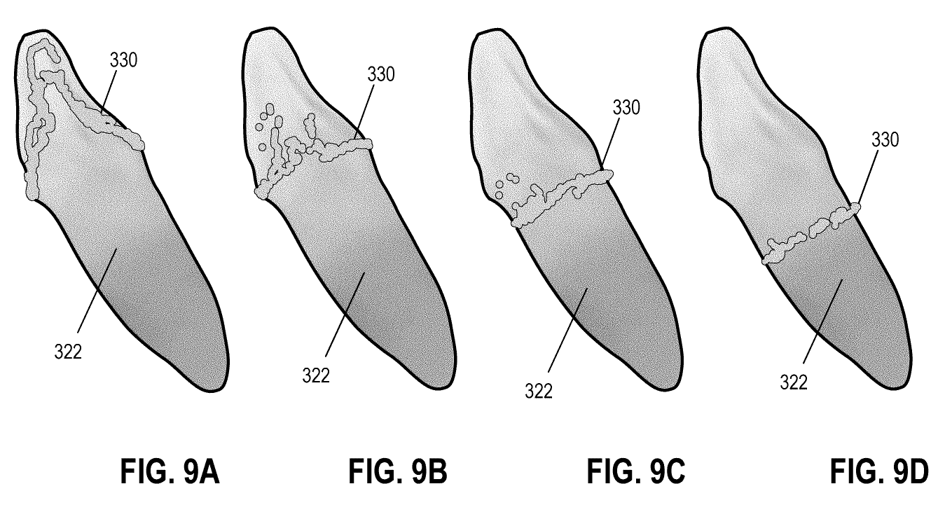

FIGS. 9A-9D illustrate a non-limiting illustrative example of a process for determining an adaptive step that focuses edge points 320 onto a plane orthogonal to the direction of the tooth root. The template tooth mesh 322 shown in FIGS. 9A-9D is for reference only. Once the direction is determined then the step size can be computed. The step size can be determined separately for each edge point 330 to have the edge points 330 gradually align in an approximate plane that is orthogonal to the root direction (see FIGS. 9A-9D). For each step that all non-converged points 330 are moved to their next voxel positions, duplicates can be removed and a history of the position of each edge point 330 can be preserved (the mantle) to be used in subsequent steps.

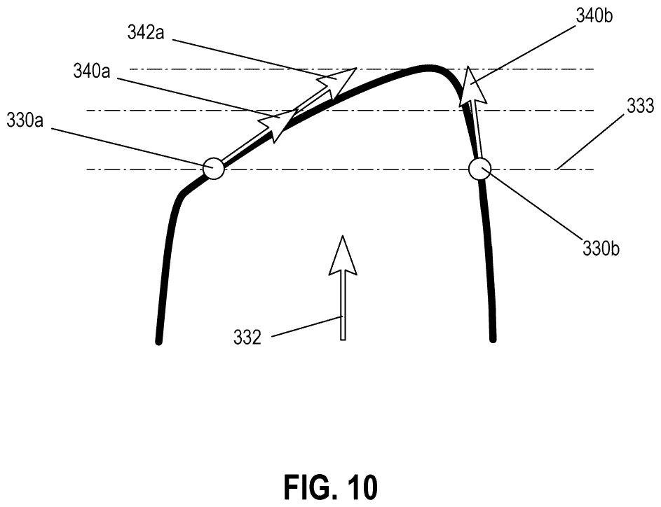

FIG. 10 illustrates a correction step that can be applied to avoid edge points 330a, 330b from moving away from co-planar alignment. FIG. 10 illustrates schematically how a correction step size can be applied to a first edge point 330a and a second edge point 330b that are co-planar in a plane 333 that is orthogonal to the root direction 332. In the illustrated schematic of FIG. 10, the projected step size 340a for the first edge point 330a is extended to a corrected step size 342a to maintain planar alignment of the first edge point 330a with the second edge points 330b within a plane orthogonal to the root direction 332.

At the end of each iteration of the second apex detection phase, a convergence check can be initiated for all un-converged edge points 330. The convergence status of an edge point 330 can change to true as the result of either a successful convergence or a stagnation. An edge point 330 can be considered stagnated when the computed edge point direction using the root direction 332 and inward direction 334 make the edge point 330 move almost parallel to the intended edge point plane near atypical local edge structures in the volumetric image data. In some configurations, the stagnation of edge points 330 can be detected computing a height estimate of the edge point 330. If the height estimate is larger than the threshold, then the edge point 330 can be marked as converged. The check for successful convergence aims to find clusters of edge points 330 projected to a two-dimensional (2D) plane and to detect whether the projected edge points 330 are converging towards an apex. To evaluate the convergence of the edge points 330, the adaptative step size can be checked to see whether it has already sufficiently aligned the edge points 330 by applying a threshold (e.g., set to 1) to the standard deviation of the projection distances to the plane. If the standard deviation lies above the threshold, the edge points 330 can be considered not yet aligned, and the process can proceed to the next iteration. Otherwise, the process can continue by clustering the projected edge points 330 and checking each cluster of edge points 330 for convergence.

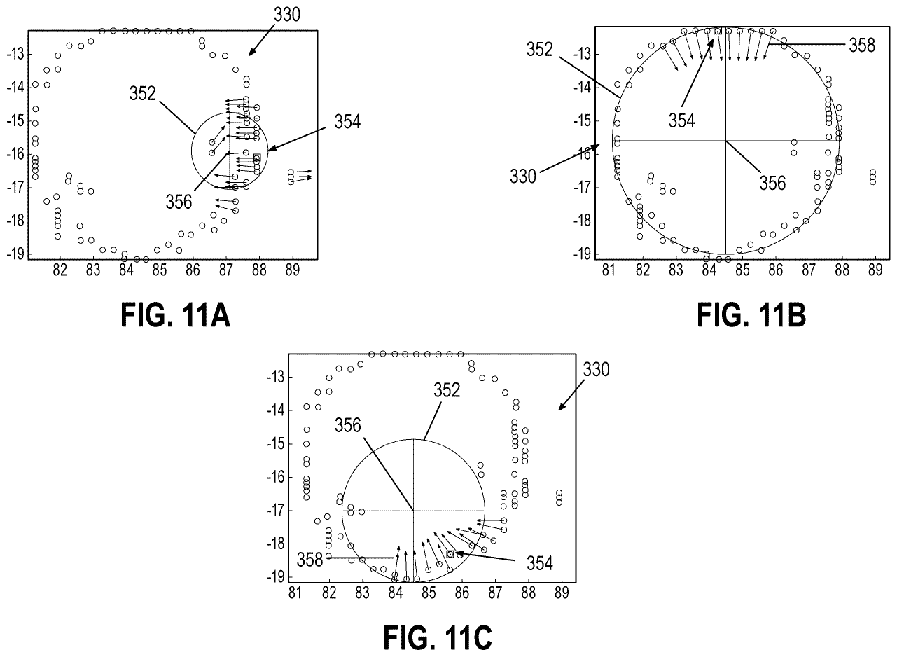

FIGS. 11A-11C show a visualization of a method for finding edge points 330 that are converging to a tooth apex. The clustering of the projected edge points 330 can be based on the detection of circular patterns. For each projected edge point 330, an approximate circle 352 will be determined based on the edge points 330 present in a small 2D Euclidean neighborhood, typically the diameter of this neighborhood is at most 3 mm, preferably at most 2 mm. Projected edge points 330 that lie close enough to the resulting circle 352 can then be classified as part of the initial cluster corresponding to the considered edge point 354. The final clusters can be extracted based on the cluster sizes. The cluster circles are computed by estimating a local circle fit for each projected edge point 330. First, a Euclidean neighborhood can be determined around a considered edge point 324 and having a radius (e.g., 2 mm radius). As depicted in FIGS. 11A-C, the circle fit can be initiated by the determination of the circle center 356 which should be positioned at the approximate intersection of the direction defined by the projected gradients 358 at the position of the edge points 330. The process can be divided in two steps. First, a set of initial clusters can be computed based on the proximity of all projected edge points 330 to the circle center 356. FIGS. 11A-11C show three different initial clusters for a given step of the algorithm. Next, taking the list of initial process, an iterative process can be performed by first taking the largest cluster and for each edge point 330 in the cluster, the edge point 330 can be removed from the other initial clusters. The process can continue by searching for the largest cluster of the updated list, and repeating the previous step, and proceeding until each edge point 330 is part of at most one final cluster. Empty clusters can be discarded.

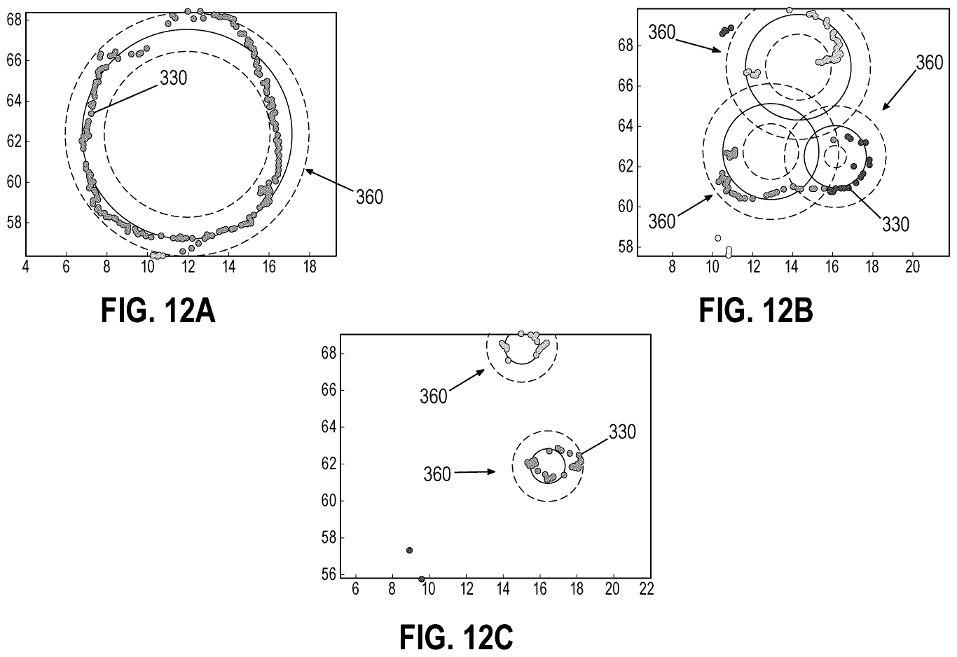

FIGS. 12A-12C show a non-limiting illustrative example of clusters 360 of edge points 330 that have passed a convergence check based on cluster size. After each iteration, the convergence of all un-converged edge points 330 can be checked and divided into the final clusters. The convergence of each final cluster 360 can be evaluated based on three conditions. First, a cluster size condition can test whether the cluster 360 is significantly large. In an arrangement the identified cluster with the largest number of edge points 330 is considered as significantly large, while a second identified cluster is only considered sufficiently large if it comprises at least 50% of the number of edge points 330 in the largest cluster. Any subsequent cluster (3^{rd} or 4^{th}) is considered significantly large if it comprises at least 35% of the number of edge points 330 in the largest cluster. Second, a radius size condition can test whether the radius associated with the final cluster 360 is small enough. Third, an inner product test can be determined between the cluster mean gradient and the root direction 332. In some configurations, the result of the inner product can be considered a pass if the result is less than a threshold value. The threshold can, but need not, be adjusted depending on the type of tooth being considered. For example, a threshold value can be set at a first value (e.g., −0.3) for a first tooth type (e.g., incisor and canine) and set at a second threshold value (e.g., −0.35) for a second tooth type (e.g., premolar) and set at a third threshold value (e.g., −0.4) for a third tooth type (e.g., molar). If a final cluster 360 passes all three conditions, the cluster 360 can be considered a converged cluster 360. FIGS. 12A-12C show final clusters 360 at the end of different apex detection iterations.

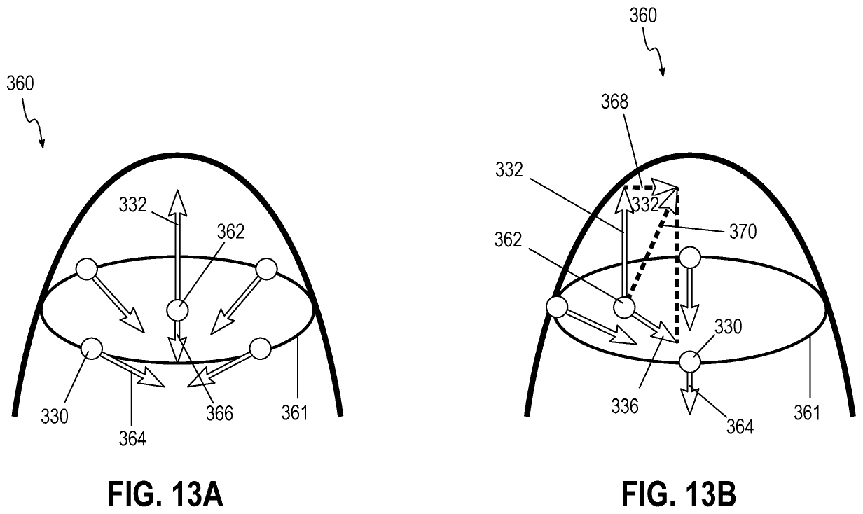

FIGS. 13A and 13B depict a schematic visualization of the various directions in the computation of a potential apex landmark. The edge points 330 in a cluster 360 are indicated by the dots disposed on a common circle 361, while the cluster center 362 is centrally disposed relative to the edge points 330. The gradient direction 364 at each of the edge points 330 is shown by arrows emanating from the edge point 330. The average gradient 366 for these edge points 330 is shown emanating from the dot at the cluster center 362. The root direction 332 is also shown in FIGS. 13A and 13B as emanating in an apical direction from the dot at the cluster center 362. The orthogonalized gradient mean 368 is shown in FIG. 13B as a dashed arrow that emanates from the head of the arrow that indicates the root direction 332. An improved apex direction 370 can be the vector sum of the root direction 332 and the orthogonalized gradient mean 368, as indicated in FIG. 13B.

To determine the most reliable apex landmark for the current tooth, the algorithm can start by evaluating which of the converged clusters 360 can be categorized as sufficiently reliable. Each cluster 360 will be assigned an apex probability that reflects its chance of representing an apex. To calculate this probability the following factors can be used: i.) the distance of the cluster 360 to the detected center of the segmented crown in the augmented image data; ii.) the inner product between the gradient mean and the root direction. For each converged cluster 360, the apex probability can then be given by the multiplication of both factors. In some arrangements, the potential apex landmark position that each converged cluster 360 would produce an apex can also be calculated. Because the clusters 360 are detected as circular contours, they typically converge slightly early, leading to a cluster center that lies slightly closer to the crown than the actual apex position. As such, the potential landmark position can be calculated with an offset.

To prevent the clusters 360 from providing invalid information to the next steps in the algorithm, a filtering operation can be added, which can be based on the position of the corresponding potential apex landmarks for the cluster 360. First, a small neighborhood of voxel positions surrounding the potential landmark can be determined. This neighborhood can be the small cube of voxel positions centered around the voxel in which the potential landmark is situated. If any of these voxel positions are outside the range of the volumetric image data or if the intensity is equal to the background intensity, then the landmark and by extension the converged cluster 360 are considered unreliable.

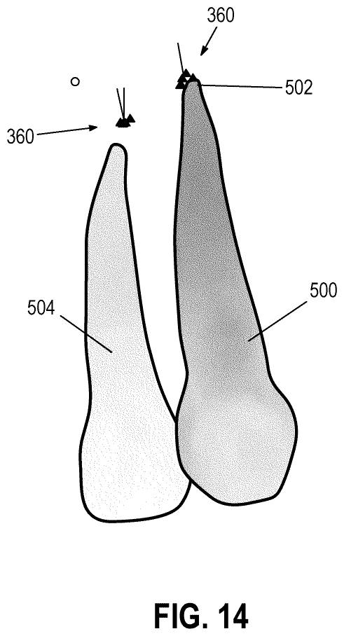

FIG. 14 shows a non-limiting exemplary embodiment of an apex detection for an upper canine 500. While the apex probability reflects the chance that the converged cluster 360 represents an apex 502, the choice probability reflects whether the found apex 502 belongs to the current tooth 500 or a neighboring tooth 504. This additional probability is especially relevant for teeth with only one root segment, which are typically narrower and have apices that can lie close to those of their neighbors (see, e.g., FIG. 14). For these teeth, the probability is defined by adding an additional factor to the apex probability which expresses that the detected center of the segmented tooth crown in the IO surface data should not lie far from the line defined by the cluster center and the root direction. For teeth that have multiple root segments, the choice probability can be taken as the same as the apex probability. Finally, the potential landmark with the highest choice probability can then be taken as the main candidate for the most reliable apex landmark. The last check consists of a reliability check for the corresponding apex probability (heuristically estimated that values greater than 70% are sufficient).

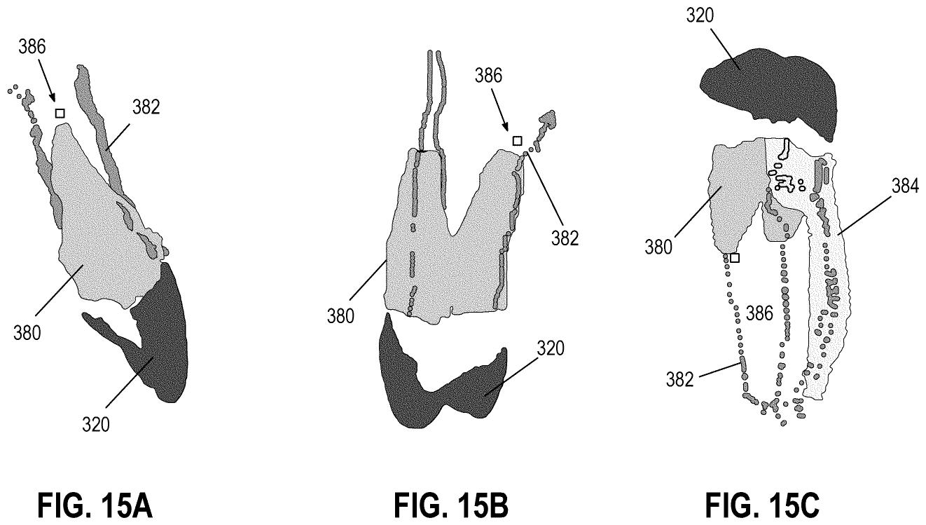

FIGS. 15A-15C depict a visualization of non-limiting exemplary apex detection results for different tooth types. The segmented crown mesh 320 is shown the darkest (i.e., black). The reliable edge point mantle 380 is shown in light gray. Unconverged edge points and their callback positions 382 are shown in medium to dark gray and appear as vertical lines. The edge points and their callback positions 384 that converged to an unreliable cluster are shown in light gray only in FIG. 15C. The most reliable apex landmark 386 is indicated by the yellow square. The backtracked paths of the edge points contained within the converged clusters is a very useful approximation to the root edges in the volumetric image data, which can be used to leverage the subsequent non-rigid registration (deformation). To extract this rough outline, or mantle, of the root, the first step can be to apply a thresholding operation to the corresponding apex probabilities to determine which converged clusters are considered reliable. The same criteria as for apex choice probability can be applied, with a probability greater than 70%. The final edge points that are a member of any of the reliable converged clusters are gathered and using the callback information their previous positions are added. After removing any doubles that occur from this set, the reliable edge point mantle is obtained. Note that it is possible for the mantle to be empty when no clusters converged, or none are considered reliable. A visualization of the mantle 380 can be seen in FIGS. 15A-15C.

As described herein, once all resulting components of the apices detection step 230 have been gathered, the actual segmentation of the tooth can be started by deforming a shape of a template tooth. The tooth template shape can be initialized using the resulting transformation obtained in the rigid initialization step 220. Next, the tooth template shape can be non-rigidly deformed to match the segmented IO crown scan. This method can start by temporarily deforming the crown mesh 320 toward the template tooth 322 to determine correspondences between both meshes. The most reliable apex landmark 386 that results from the apices detection step 230 can be used to determine the nearest apex landmark of the template shape (after rigid initialization) and add this correspondence to the correspondences at crown level. Based on the final set of correspondences, the template tooth mesh 322 can be deformed towards the segmented IO crown mesh using ICP. This non-rigidly deformed template tooth now provides a closed tooth mesh accurately matching the segmented crown surface and comprising a template root mesh section of which the length approximates the actual root length due to the inclusion of an apex landmarks. So, when the apex landmark correspondence is included, the deformation will roughly initialize the length and orientation of the root. Even when the root consists of multiple root segments, the segments for which no landmark correspondence is present will also be roughly initialized through the deformation model.

After the non-rigid initialization of the crown surface, the positions of the vertices in the root portion of the deformed template tooth are repositioned towards the root edges as identified in the volumetric image using an optimization method. In the coarse non-rigid root registration step 240 of the dental segmentation algorithm, a registration of the root vertices of the template shape to the reliable edge point mantle can be performed. The goal is to gradually deform the root vertices in the template tooth 322 towards the mantle 380, starting close to the crown and moving step by step toward the apices. During the upcoming deformations, it can be desired to only move the vertices marked as root in the mesh while keeping the vertices marked as crown fixed. Smart sampling can be used to select only a subset of crown vertices to reduce the computation time required. The same spatially uniform sampling can be applied to the mantle 380 for computational efficiency and independence of voxel size.

In an embodiment, the labeling of the vertices of the deformed template tooth mesh comprises determining for each vertex on the deformed template tooth mesh the distance to the nearest point on the segmented crown surface mesh, preferably such nearest point is not restricted to a vertex of the segmented IO crown surface but can also lie on any of the faces or edges of said surface. If for a vertex of the deformed template tooth this distance is lower than a given threshold, such as below 0.4, 0.3, 0.2 or 0.1 mm, said vertex is labeled as part of the crown surface, otherwise said vertex is labeled as part of the root surface. Note that the deformed template tooth vertices in the interstice crown regions (which are not present in the segmented crown surfaces) will be labeled as root vertices. For teeth with deep indentations in the crown surface, such as molars, the non-rigid deformation of the template tooth may at certain positions not perfectly match the segmented crown surfaces, resulting in a few isolated vertices of the deformed template tooth that are at a distance from the segmented crown surface exceeding said distance threshold. These deformed template tooth vertices will be labeled as root. Therefore, it is preferred that an operation is applied to the vertices labeled as root to only retain the largest connected part. The vertices that are initially labeled as root but which are not part of the largest connected part have their label changed to crown in said operation.

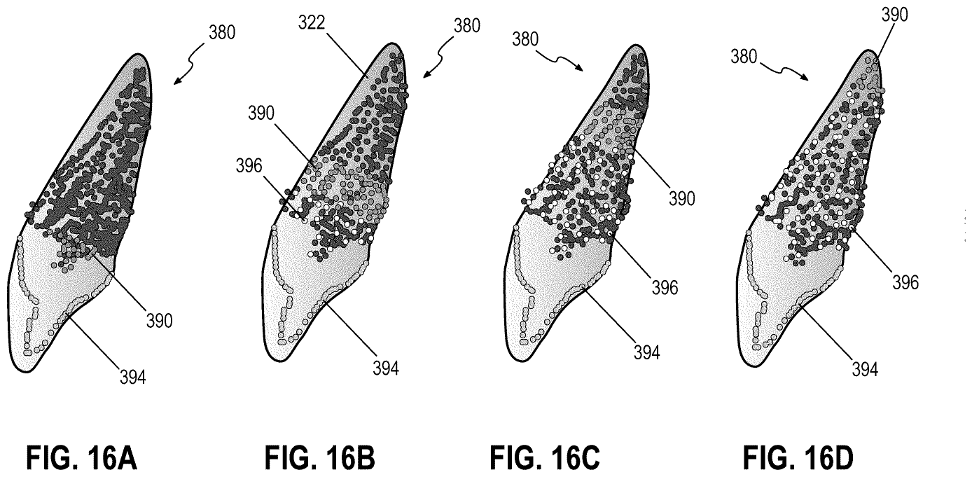

FIGS. 16A-16D depict a visualization of different edge point sets that can be used in the non-rigid root initialization. In order to perform the registration of the root section of the (deformed) template tooth mesh 322 to the mantle gradually from crown to apex, a set of sequential, possibly overlapping, bands can be defined based on the Euclidean distances between mantle points 380 and the detected crown center for the current tooth in the IO scan. A visualization of these bands is shown in FIGS. 16A-16D. In FIGS. 16A-16D, the fixed crown vertices 394 are indicated by gray dots and generally follow the crown. The active band 390 are the mantle points 380 that are shown as gray dots and appear as patches outline in dash-dash line that appear sequentially from the crown to the apices in FIGS. 16A-16D. The mantle points 380 that are part of a further subsampled set 396 are indicated by light gray dots. In some arrangements, the root shape can now be deformed towards the subsampled mantle using a non-rigid registration approach. The method will perform n-iterations, where the k-th iteration is linked to the band which will be referred to as the active band 390 for that iteration. Based on the active band 390, the correspondences between the vertices in the template tooth mesh 322 and the (subsampled) mantle points 380 are determined. These correspondences are then used in a thin-plate spline deformation that is applied to all root vertices in the root shape. After the final deformation in the n-th iteration, the resulting root shape will be the result of the mantle registration. During iteration k of the non-rigid registration approach, two sets of the correspondences between the subsampled mantle and the current template tooth shape are determined. The first set focuses on mantle points 380 in the active band 390, while the second set is constructed very similarly using mantle points 380 in the subsampled mantle.

Typically the coarse registration of the root vertices of the template tooth on the rough outline (mantle) in the volumetric image data, is followed by performing a finer registration 250 of the root vertices of the template tooth to the volumetric image data itself is performed. Alternatively, the fine registration 250 is performed immediately after the non-rigid registration of the template tooth to the segmented crown surface, i.e., without the preceding coarse registration to the mantle. Preferably, this fine repositioning of root labeled vertices comprises a preprocessing of the volumetric image data of the one or more teeth to be segmented. In an embodiment this pre-processing comprises cropping the volumetric image data to a bounding box enclosing a registered deformed template tooth. This bounding box may tightly enclose the deformed template tooth. Preferably, the tightly defined bounding box is expanded on all six sides with one or more voxels defining a region covering the expected region of the image in which the tooth is located. For instance, said tightly defined bounding box may be expanded with [4/m] voxels on all six sides, wherein m is the minimal voxel size over all its dimensions. In case the expanded bounding box falls outside of the original volumetric image volume, the side of the expanded bounding box outside of the volumetric image is reduced to coincide with the volumetric image data boundary. Subsequently, the cropped image is smoothed using for instance a Gaussian filter. Thereafter, the image intensities of the smoothed image can be normalized between 0 and 1. Preferably, the root-labeled vertices in a deformed template tooth are repositioned using a said optimization method towards the tooth edges as identified in the smoothed and normalized cropped image encompassing said deformed template tooth. The resulting image can be used in the evaluation of the cost functions in an upcoming optimization method. Similar to the mantle registration, the fine registration can also use a gradual banded approach. In this case, the root vertices can be gathered into sequential, possibly overlapping, bands from the crown towards the apices. During each iteration k of the fine registration, an optimal deformation of the root can be determined based on the current active band. This optimal deformation can then be applied to all root vertices that lie within the band or further from the tooth crown. M ore particularly, said fine repositioning of the root labeled vertices of a deformed template tooth takes advantage of the already accurate positioning of its crown labeled vertices because of the non-rigid deformation of said template tooth to match the segmented crown surface. In an embodiment, the repositioning of the root labeled vertices involves assigning each of said root labeled vertices to one of a series of sequential bands depending on the distance of said root labeled vertex and a tooth apex position calculated from the one or more identified apex positions for a said tooth. The banded approach according to this embodiment permits a gradual repositioning of the root labeled vertices using an optimization method, which considers the certain positioning of the crown labeled vertices and propagates this certainty from the region near the crown towards the apex. Preferably, said series of bands on the deformed model tooth surface partially overlap. Once the consecutive bands are defined, the optimization method is applied to each band before moving on to the next one. For each band [symbol] ₖ, the optimization method determines the optimal deformation, which is applied to all template root vertices that both lie within the band [symbol] ₖ as well as those that lie below the band, i.e., closer to said tooth apex position. After the deformation is applied, the vertex normals of the template tooth are recomputed and the method continues with the optimization of the next band [symbol] ₖ₊1. The deformation itself can be executed using a thin-plate spline deformation with variable stiffness. The stiffness can be relaxed, since it is possible to allow more local deformations of the template shape because of the improved starting position.

A cost function that can be used to evaluate a specific deformation can include three separate terms: a gradient norm-based term; a term based on the inner product between the image gradient and the vertex normal; and an intensity uniformity cost term. This cost function profile can encourage the optimization to improve the template fit when close to a favorable solution, while avoiding excessive deformations when placed in a suboptimal position in locally noisy volumetric image data. Finally, the optimal deformation during each iteration k can be found by minimizing the cost functions using a trust-region optimization method. After optimization of the positions of the root labeled vertices in the last (apical) band, typically the registered template tooth accurately matches both the segmented crown surfaces and the tooth edges as identified in the volumetric image, thus providing an accurate segmentation of the selected tooth.

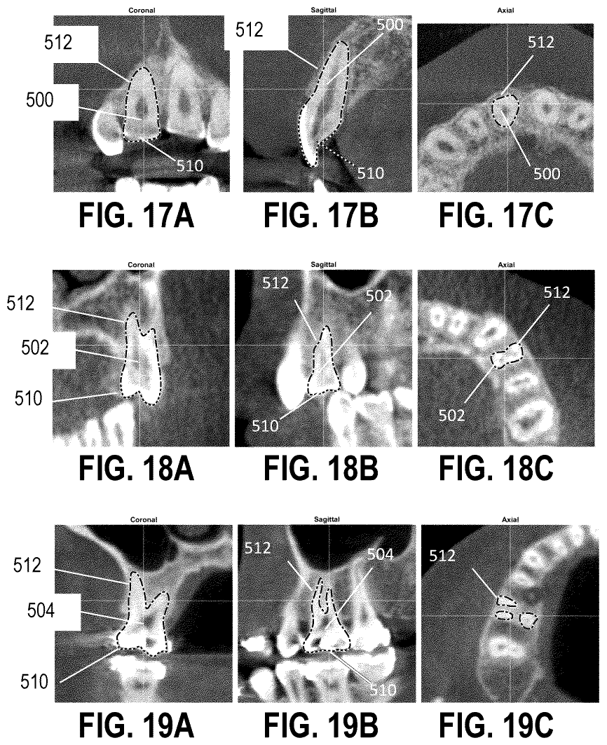

After the automatic dental segmentation finishes, the reconstructed roots can have the position, size, direction and shape of the ones in the volumetric image data. FIGS. 17A-19C show the contours from different views for an incisor 500, a premolar 502, and a molar 504, where the IO-scan cross-section 510 with the CBCT slice is shown in dot-dot line and the registered-template cross-section 512 with the CBCT slice is shown in dot-dash line. FIGS. 17A-17C show coronal-, sagittal-, and axial-plane views, respectively, of a point mapping as determined by the automated dental segmentation for an incisor 500, according to some aspects of the present disclosure. FIGS. 18A-18C show coronal-, sagittal-, and axial-plane views, respectively, of a point mapping as determined by the automated dental segmentation for a premolar, according to some aspects of the present disclosure. FIGS. 19A-19C show coronal-, sagittal-, and axial-plane views, respectively, of a point mapping as determined by the automated dental segmentation for a molar, according to some aspects of the present disclosure.

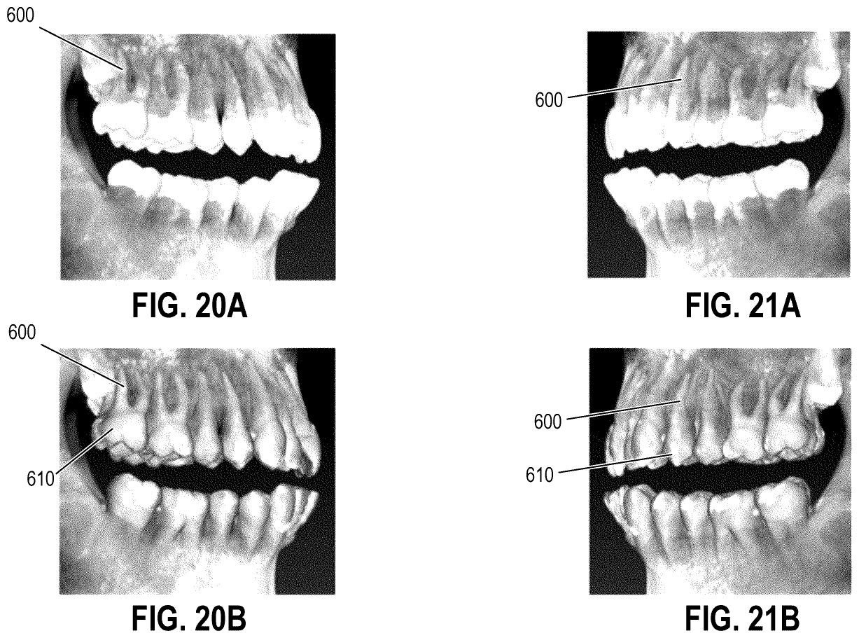

FIGS. 20A and 20B depict a 3D visualization of the results of an automated dental segmentation, according to some aspects of the present disclosure. FIG. 20A shows a right view CBCT image 600 of a patient without the fitted template teeth 610 of the present disclosure. FIG. 20B shows a right view CBCT image 600 of the patient with the fitted template teeth 610 of the present disclosure overlaid on the CBCT image 600.

FIGS. 21A and 21B depict a 3D visualization of the results of an automated dental segmentation, according to some aspects of the present disclosure. FIG. 21A shows a left view CBCT image 600 of a patient without the fitted template teeth 610 of the present disclosure. FIG. 21B shows a left view CBCT image 600 of the patient with the fitted template teeth 610 of the present disclosure overlaid on the CB CT image 600.

FIG. 22 shows validation results for two data sets. Data Set 1 has cases that are typically found in orthodontic treatments. Data Set 2 contains generic cases, which could have dental braces or crown dental fillings affecting image quality of the CBCT scan. Success rates are shown for the full data set (Data Set 1+Data Set 2) and for a filtered data set from which the out-of-scope cases have been removed. A comparison of success rates for teeth with or without braces is also shown for the filtered data. FIG. 22 also shows for the filtered data a comparison of success rates for teeth with or without crown dental fillings. The bottom table in FIG. 22 shows a comparison of success rates for different teeth types for the filtered data. In the table, the abbreviations U and L denote upper or lower teeth, and the abbreviations I, C, P, and M denote incisor, canine, premolar, and molar, respectively.

### Other Variations and Terminology

While certain embodiments have been described, these embodiments have been presented by way of example only, and are not intended to limit the scope of protection. Indeed, the novel methods and systems described herein may be embodied in a variety of other forms. It will be understood by those skilled in the art that the present disclosure extends beyond the specifically disclosed embodiments to other alternative embodiments or uses and obvious modifications and equivalents thereof, including embodiments which do not provide all of the features and advantages set forth herein. Furthermore, various omissions, substitutions, and changes in the form of the methods and systems described herein may be made. Those skilled in the art will appreciate that in some embodiments, the actual steps taken in the processes illustrated or disclosed may differ from those shown in the figures. Depending on the embodiment, certain of the steps described above may be removed; others may be added. Accordingly, the scope of the present disclosure is not intended to be limited by the specific disclosures of preferred embodiments herein, and may be defined by claims as presented herein or as presented in the future. The language of the claims is to be interpreted broadly based on the language employed in the claims and not limited to the examples described in the patent specification of during prosecution of the application, which examples are to be construed as non-exclusive.

Features, materials, characteristics, or groups described in conjunction with a particular aspect, embodiment, or example are to be understood to be applicable to any other aspect, embodiment, or example described herein unless incompatible therewith. All of the features disclosed in this specification (including any accompanying claims, abstract, and drawings), or all of the steps of any method or process so disclosed, may be combined in any combination, except combinations where at least some of such features or steps are mutually exclusive. The protection extends to any novel one, or any novel combination, of the features disclosed in this specification (including any accompanying claims, abstract, and drawings), or to any novel one, or any novel combination, of the steps of any method or process so disclosed.

Conditional language, such as “can,” “could,” “might,” or “may,” unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of the stated amount. As another example, the terms “generally parallel” and “substantially parallel” may refer to a value, amount, or characteristic that departs from exactly parallel by less than 15 degrees.

1. A computer-implemented method for segmenting a tooth model from volumetric image data and intraoral surface data of a subject's dental anatomy comprising the steps of:
providing volumetric image data of the dental anatomy;
providing intraoral surface data of the dental anatomy;
generating augmented image data by aligning the surface data and the volumetric image data;
segmenting crown sections of teeth in the intraoral surface data;
selecting a template tooth from a template tooth library, wherein the tooth identification of the template tooth corresponds to the tooth identification of a tooth of the augmented image data;
fitting the corresponding template tooth to said tooth of the augmented image data; and
segmenting the tooth in the volumetric image data based on the fitted template tooth.

2. The computer-implemented method according to claim 1, wherein fitting the corresponding template tooth to the tooth of the augmented image data comprises aligning the corresponding template tooth to the segmented crown section of said tooth of the augmented image data.

3. The computer-implemented method according to claim 2, wherein fitting the corresponding template tooth to the tooth in augmented image data further comprises a scaled rigid transform of the corresponding template tooth relative to the segmented crown section of said tooth in the augmented image data.

4. The computer-implemented method according to claim 1, further comprising selecting two or more template teeth from a template tooth library,
wherein the tooth identification of each of the selected template teeth corresponds to the tooth identification of a tooth of the augmented image data and wherein a crown center position is determined for each selected template tooth;
virtually positioning the selected template teeth into a dental arch; and
performing a scaled rigid transformation of said virtual dental arch mapping the crown center positions of said template teeth to the crown center position as determined for the segmented crown sections of the corresponding teeth in the augmented image data.

5. The computer-implemented method according to claim 4, further comprising rigidly scaling the template teeth based on the distances between the crown center positions of corresponding neighboring teeth in the augmented image data.

6. The computer-implemented method according to claim 4, further comprising a scaled rigid transform of the template teeth relative to the segmented crown sections of the respective teeth of the augmented image data to which said template teeth are mapped.

7. The computer-implemented method according to claim 1, further comprising determining an outline of the root section of a tooth in the augmented image data,
wherein determining said outline comprises determining edge points of said tooth in the volumetric image data starting from the edge points coinciding with the apical border of the segmented crown section of the aligned surface data and propagating these edge points in an apical direction along the root edge of said tooth in the volumetric image data.

8. The computer-implemented method according to claim 7, wherein propagating the edge points in an apical direction along the root edge of the tooth in the volumetric image data is an iterative stepwise process guided by a root direction and an inward direction at a current edge point of a given iteration,
wherein said root direction provides an indication of the direction towards a root apex position, and
wherein the inward direction is provided by the gradient direction at a given edge position of said tooth.

9. The computer-implemented method according to claim 8, wherein providing the root direction for a tooth of the augmented image data comprises aligning a template tooth to said tooth of the augmented image data, wherein the tooth identification of the template tooth corresponds to the tooth identification of said tooth of the augmented image data.

10. The computer-implemented method according to claim 9, wherein providing the root direction for the tooth of the augmented image data further comprises a scaled rigid transform of the corresponding template tooth relative to the segmented crown surface of said tooth of the augmented image data.

11. The computer-implemented method according to claim 8, wherein the root direction for a tooth in the augmented image data is an adaptive direction provided by the direction between the crown center of said tooth and the center of a current collection of edge points in a given iteration.

12. The computer-implemented method according to claim 7, wherein a collection of edge points is tested for convergence towards a same position at each iteration.

13. The computer-implemented method according to claim 12, wherein an apex landmark position is derived from a collection of edge points which passed the convergence test.

14. The computer-implemented method according to claim 13, wherein the outline of the root section of a tooth in the augmented image data is determined by the voxel positions of the edge points detected in the iterative steps leading up to a said converging collection of edge points.

15. The computer-implemented method according to claim 1, wherein fitting the corresponding template tooth to the tooth of the augmented image data further includes deforming the template tooth to a deformed template tooth mesh that matches the segmented crown section and preferably a root apex landmark position of the tooth of the augmented image data.

16. The computer-implemented method according to claim 15, wherein vertices of the deformed template tooth are labeled as crown vertices or root vertices based on the proximity between the deformed template tooth mesh and the segmented crown section of the matching tooth of the augmented image data.

17. The computer-implemented method according to claim 15, wherein fitting the corresponding template tooth to the tooth of the augmented image data further includes deforming the root section of the deformed template tooth mesh to align the vertices of the root section with an edge of the selected tooth in the volumetric image data.

18. The computer-implemented method according to claim 17, wherein deforming the root section of the deformed template tooth mesh to align the vertices of the root section with an edge of the selected tooth in the volumetric image data comprises a coarse registration step wherein the vertices of the root section of the deformed template tooth mesh are aligned with the outline of the root of the tooth in the augmented image data as determined according to claims 7 to 12.

19. The computer-implemented method according to claim 18, wherein said coarse registration step is followed by a fine registration step wherein the root section of the deformed template tooth mesh is further registered to the root edge of the corresponding tooth in the volumetric image data of the augmented image data.

20. The computer-implemented method according to claim 1, wherein the template tooth comprises a crown section mesh and a root section mesh, with the mesh density of the crown section mesh being higher than the mesh density of the root section mesh.

21. A computer system comprising: memory; and a processor in communication with the memory and configured with processor-executable instructions to perform operations comprising:
receiving volumetric image data of a subject's dental anatomy;
receiving intraoral surface data of the dental anatomy;
generating augmented image data by aligning the surface data and the volumetric image data;
segmenting crown sections of teeth in the intraoral surface data;
selecting a template tooth from a template tooth library, wherein the tooth identification of the template tooth corresponds to the tooth identification of a tooth of the augmented image data;
fitting the corresponding template tooth to said tooth of the augmented image data; and
segmenting the tooth in the volumetric image data based on the fitted template tooth.

22. A non-transitory computer readable medium storing computer executable instructions that, when executed by one or more computer systems, configure the one or more computer systems to perform operations comprising:
receiving volumetric image data of a subject's dental anatomy;
receiving intraoral surface data of the dental anatomy;
generating augmented image data by aligning the surface data and the volumetric image data;
segmenting crown sections of teeth in the intraoral surface data;
selecting a template tooth from a template tooth library, wherein the tooth identification of the template tooth corresponds to the tooth identification of a tooth of the augmented image data;
fitting the corresponding template tooth to said tooth of the augmented image data; and
segmenting the tooth in the volumetric image data based on the fitted template tooth.
